(19) United States
(12) Patent Application Publication
(10) Pub. No.: US 2025/0372983 A1
(43) Pub. Date: Dec. 4, 2025

(54) ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Hirokuni Kurashiki, Susono-shi (JP)

(21) Appl. No.: 19/186,580

(22) Filed: Apr. 22, 2025

(30) Foreign Application Priority Data
May 29, 2024 (JP) 2024-087290

(51) Int. Cl. H02G 3/16; B60R 16/023

(52) U.S. Cl. CPC H02G 3/16; B60R 16/0238

(57) ABSTRACT

An electrical connection unit includes an electronic component including a terminal at a component end in a second direction, a routing board including a base member and a bus bar, and a connection component including a first portion having a first attachment hole and having a posture of standing in the first direction with respect to a first surface, and a second portion having a second attachment hole and protruding along the first surface from an end of the first portion on a first surface side, in which the position of the second attachment hole is shifted from the position aligned in the second direction with respect to the position of the first attachment hole in a plan view viewed from the first direction.

### BACKGROUND OF THE INVENTION

### Field of the Invention

Embodiments of the present invention relate to an electrical connection unit.

Priority is claimed on Japanese Patent Application No. 2024-087290 filed in Japan on May 29, 2024, the content of which is incorporated herein by reference.

### Description of the Related Art

An electrical connection unit having a housing that accommodates electronic components and a bus bar attached to the housing in a standing posture is known. [Patent Document 1] Japanese Unexamined Patent Application, First Publication No. 2024-037492

### SUMMARY OF THE INVENTION

Incidentally, an electrical connection unit tends to increase in size with an increase in current of the electrical connection unit.

An embodiment provides an electrical connection unit that can curb an increase in size.

According to an embodiment, there is provided an electrical connection unit including an electronic component including a terminal at a component end in a second direction; a routing board including a base member having a first surface facing the electronic component and including a plate-shaped or sheet-shaped flat surface portion having a thickness in a first direction, and a bus bar held by the flat surface portion, extending along the flat surface portion, and including a connection portion; and a connection component including a first portion having a first attachment hole extending in the second direction and having a posture of standing in the first direction with respect to the first surface, and a second portion having a second attachment hole extending in the first direction and protruding along the first surface from an end of the first portion on the first surface side, the connection component being disposed between the electronic component and the bus bar and electrically connecting the terminal to the connection portion, in which in a plan view viewed from the first direction, the position of the second attachment hole is shifted from a position aligned in the second direction with respect to the position of the first attachment hole.

According to one embodiment, it is possible to curb an increase in size of the electrical connection unit.

### BRIEF DESCRIPTION OF THE DRAWINGS

FIG. 1 is a cross-sectional view illustrating an electrical connection unit according to an embodiment;

FIG. 2 is a perspective view for describing a main body of the embodiment;

FIG. 3 is a perspective view illustrating a subunit of the embodiment;

FIG. 4 is a partially exploded perspective view of the subunit of the embodiment;

FIG. 5 is a partially exploded perspective view of an electronic component and a connection component according to the embodiment;

FIG. 6 is an enlarged perspective view illustrating a main part of the subunit of the embodiment;

FIG. 7 is an enlarged plan view illustrating the main part of the subunit of the embodiment;

FIG. 8 is a cross-sectional view taken along line F8-F8 of the structure illustrated in FIG. 10;

FIG. 9 is a perspective view illustrating a routing board according to the embodiment;

FIG. 10 is a plan view illustrating the routing board according to the embodiment;

FIG. 11 is a partially exploded perspective view of the electrical connection unit according to the embodiment;

FIG. 12 is a bottom view illustrating the routing board of the embodiment;

FIG. 13 is a cross-sectional view for describing a method of manufacturing the electrical connection unit of the embodiment;

FIG. 14 is a cross-sectional view for describing the method of manufacturing the electrical connection unit of the embodiment;

FIG. 15 is a cross-sectional view for describing the method of manufacturing the electrical connection unit of the embodiment;

FIG. 16 is a cross-sectional view for describing the method of manufacturing the electrical connection unit of the embodiment;

FIG. 17 is a cross-sectional view for describing the method of manufacturing the electrical connection unit of the embodiment; and

FIG. 18 is a view for describing the action of the electrical connection unit of the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively. The “sheet-shaped” or “sheet” is not limited to a member having a thickness of 1 mm or more, and a member (so-called a film) having a thickness of less than 1 mm can also be used.

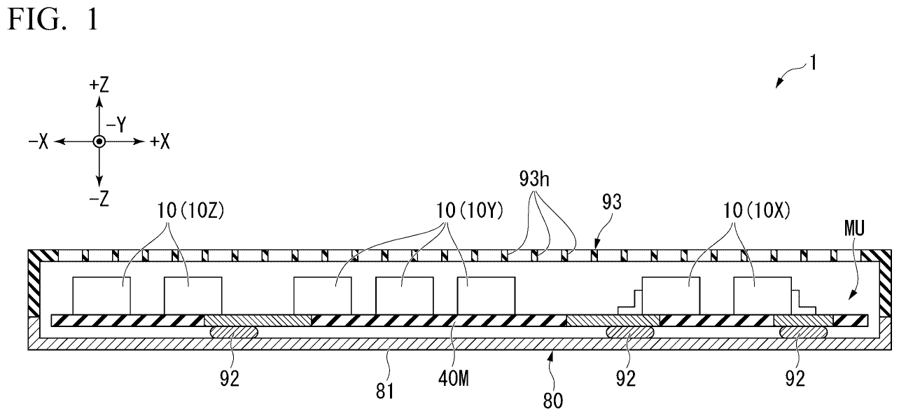

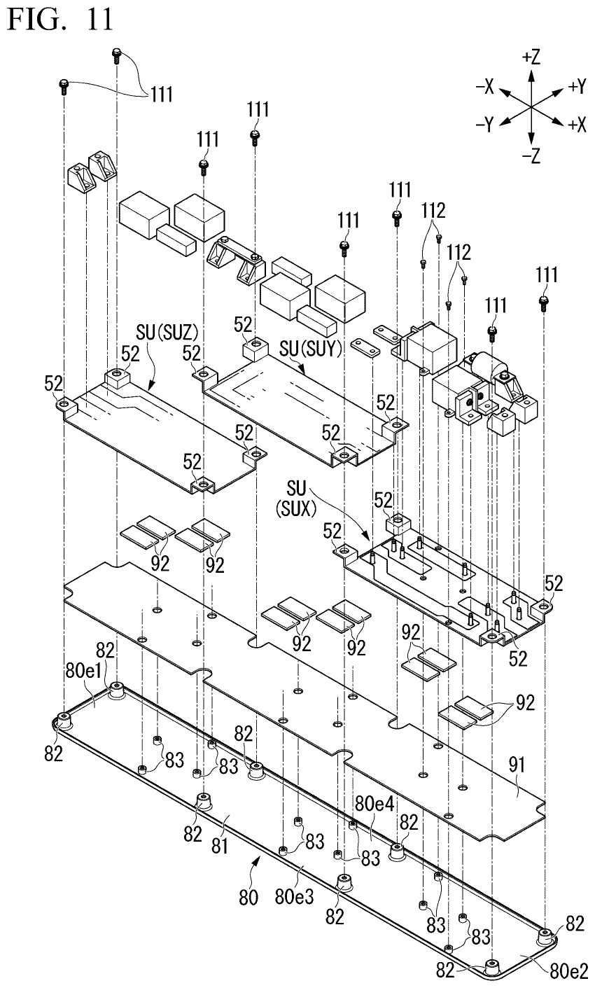

In the present disclosure, a +X direction, a −X direction, a +Y direction, a −Y direction, a +Z direction, and a −Z direction are defined as follows. The +X direction is a direction from a first end 80e1 to a second end 80e2 of a metal plate 80 that will be described later (see FIG. 11). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 80e3 to a fourth end 80e4 of the metal plate 80 that will be described later (see FIG. 11). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from the metal plate 80 that will be described later toward a main body MU (see FIG. 1). The −Z direction is a direction opposite to the +Z direction. Hereinafter, in a case where the +Z direction and the −Z direction are not distinguished, the directions will be simply referred to as “Z direction”. The Z direction is an example of a “first direction”. The X direction is an example of a “second direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### Embodiment

### 1. Constitution of Electrical Connection Unit

FIG. 1 is a cross-sectional view illustrating an electrical connection unit 1 of the present embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 is electrically connected to an external device. In the present disclosure, the “external device” is an electrical device existing outside the electrical connection unit 1. The external device is, for example, a battery unit mounted on a vehicle or an inverter for driving a motor of the vehicle, but is not limited to these examples.

The electrical connection unit 1 includes, for example, a main body MU, a metal plate 80, an insulating sheet 91 (see FIG. 11), a plurality of heat transfer members 92, and an insulating cover 93.

### 2. Main Body

First, the main body MU will be described.

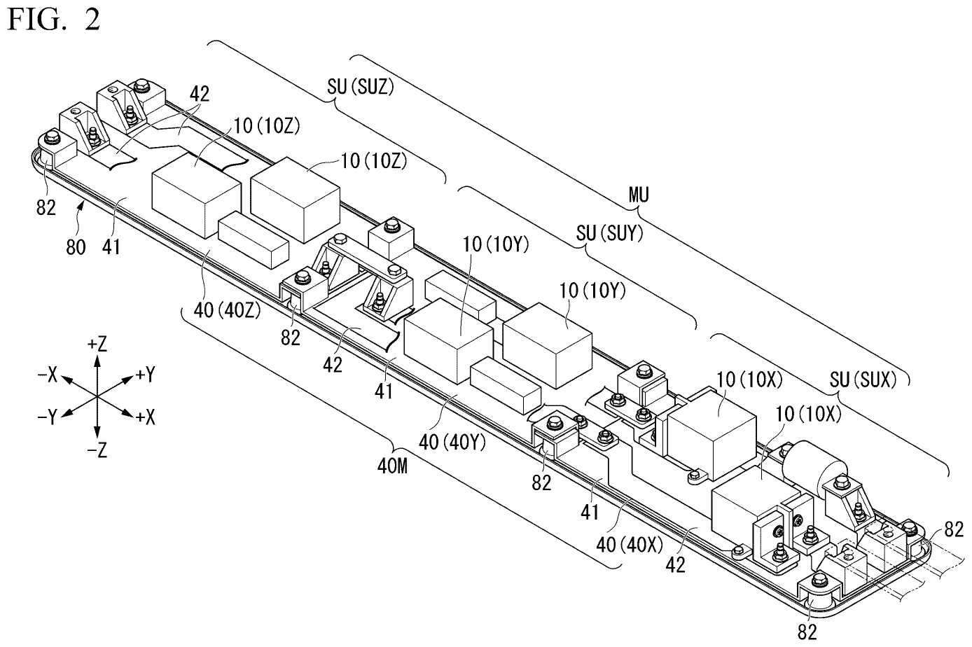

FIG. 2 is a perspective view for describing the main body MU. The main body MU is a portion that performs a main function (for example, switching of electrical connection states or overcurrent protection) of the electrical connection unit 1. In the present embodiment, the main body MU is divided into a plurality of subunits SU. The main body MU is formed by connecting a plurality of subunits SU. In the present embodiment, the main body MU includes three subunits SU (subunits SUX, SUY, and SUZ). Each subunit SU may be referred to as a “circuit constitution body”.

The subunit SUX has an electrical first function. The subunit SUX includes, for example, a plurality of electronic components 10X and a routing board 40X. The plurality of electronic components 10X are electrically connected to the routing board 40X.

The subunit SUY has an electrical second function. The second function is a function different from the first function. The subunit SUY includes, for example, a plurality of electronic components 10Y and a routing board 40Y. The plurality of electronic components 10Y are electrically connected to the routing board 40Y.

The subunit SUZ has an electrical third function. The third function is a function different from the first function and the second function. The subunit SUZ includes, for example, a plurality of electronic components 10Z and a routing board 40Z. The plurality of electronic components 10Z are electrically connected to the routing board 40Z.

In the present embodiment, the three subunits SUX, SUY, and SUZ are disposed to be arranged in the X direction.

In the present embodiment, the three routing boards 40X, 40Y, and 40Z included in the three subunits SUX, SUY, and SUZ are disposed on the same plane. In other words, the three routing boards 40X, 40Y, and 40Z are disposed at the same height position in the Z direction. One large routing board 40M is formed by the three routing boards 40X, 40Y, and 40Z being disposed.

In the present embodiment, the three subunits SUX, SUY, and SUZ have the same or similar basic structure. Hereinafter, one subunit SU will be described in detail as a representative. Hereinafter, the subunit SUX, the subunit SUY, and the subunit SUZ are not distinguished and are simply referred to as “subunit SU”. In addition, the electronic component 10X, the electronic component 10Y, and the electronic component 10Z are not distinguished and are simply referred to as “electronic components 10”. In addition, the routing board 40X, the routing board 40Y, and the routing board 40Z are not distinguished from one another and are simply referred to as “routing board 40”.

### 3. Constitution of Subunit

Next, a constitution of the subunit SU will be described.

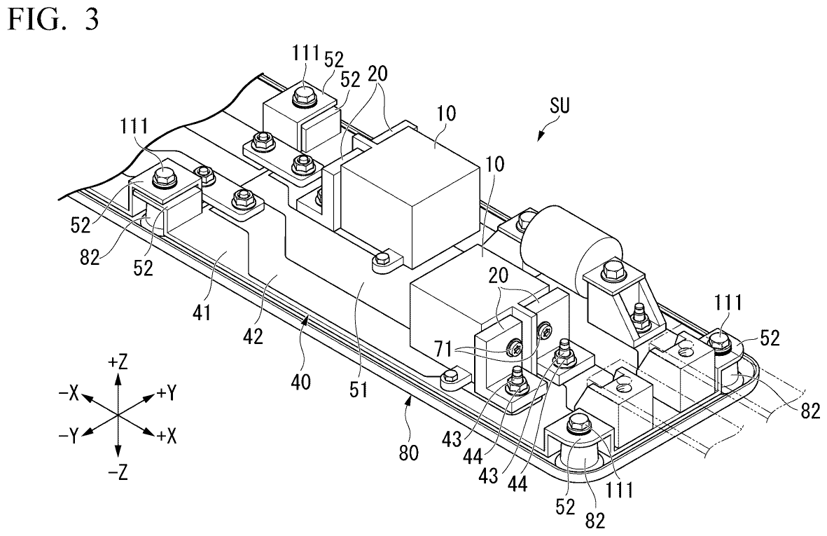

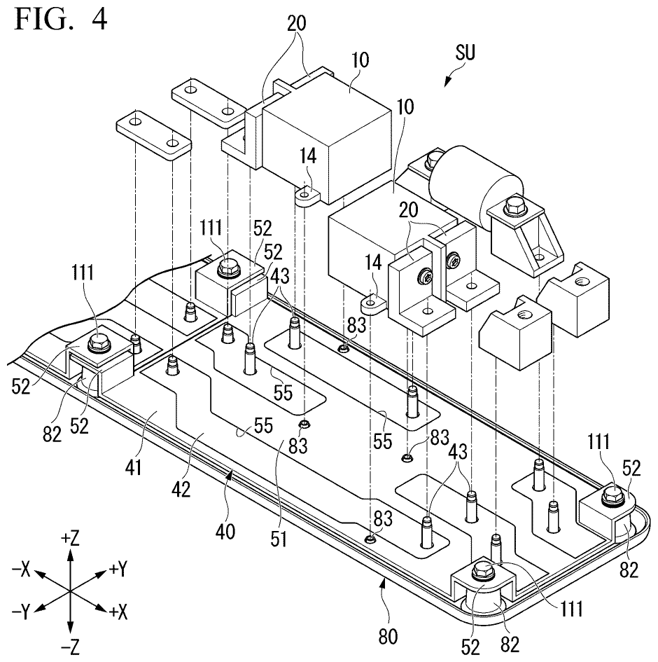

As illustrated in FIGS. 3 and 4, the subunit SU includes, for example, a plurality of electronic components 10, a plurality of connection components 20 for component connection, and a routing board 40. Each connection component 20 is a member forming an energization path in the vertical direction. The connection component 20 may be referred to as a “vertical routing member”.

### <3.1 Electronic Component and Connection Component for Component Connection>

First, the electronic component 10 and the connection component 20 for component connection will be described.

The electronic component 10 is an electronic component mounted according to a function required for the subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. The electronic component 10 is provided on the +Z direction side of the routing board 40. Note that the type of the electronic component 10 is not limited to the above example. The electronic component 10 is, for example, a heat generating component that generates heat at the time of energization.

The connection component 20 is a component that electrically connects the electronic component 10 to the routing board 40. The connection component 20 forms part of an energization path in the subunit SU. The connection component 20 is provided on the +Z direction side of the routing board 40. The connection component 20 is made of a metal (for example, copper or a copper alloy). The connection component 20 may be referred to as a “metal component”.

### <3.1.1 Electronic Component>

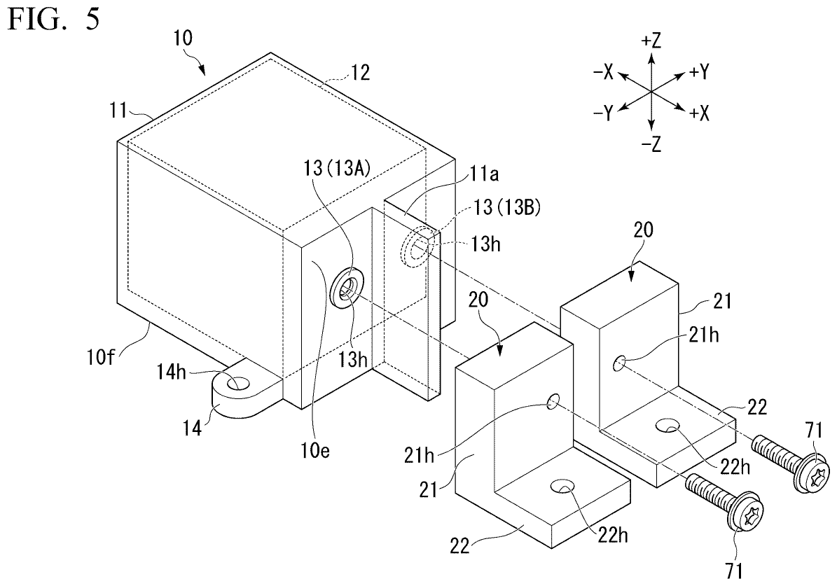

As illustrated in FIG. 5, the electronic component 10 is an electronic component in which a plurality of terminals 13 are disposed to be arranged at one component end 10e of the electronic component 10. The electronic component 10 includes, for example, a case 11, a component body 12, a plurality of terminals 13, and a plurality of attachment portions 14.

### (Case)

The case 11 is an outer member that forms most of the outer shape of the electronic component 10. The case 11 is made of, for example, synthetic resin and has an insulating property. The case 11 accommodates the component body 12. The case 11 and the component body 12 may be integrally formed.

In the present embodiment, the case 11 has an insulating rib 11a that protrudes in the horizontal direction (for example, the X direction) and extends in the Z direction. The insulating rib 11a has, for example, a plate shape formed in the horizontal direction (for example, the X direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, part of the insulating rib 11a is disposed between the first portions 21 (that will be described later) of the two connection components 20 connected to the electronic component 10. The insulating rib 11a electrically insulates between the first portions 21 of the two connection components 20 connected to the electronic component 10.

### (Component Body)

The component body 12 is a portion that performs a main function of the electronic component 10. For example, in a case where the electronic component 10 is a relay, the component body 12 includes a switch (for example, a contact) that switches between a conductive state and a non-conductive state. For example, in a case where the electronic component 10 is a fuse, the component body 12 includes a fusion portion that is fused when an overcurrent flows. For example, in a case where the electronic component 10 is a capacitor, the component body 12 includes a portion that stores electric charge.

### (Terminal)

The terminal 13 is an electrical connection portion exposed to the outside of the case 11. The terminal 13 is electrically connected to the component body 12 inside the case 11. In the present embodiment, the electronic component 10 includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one component end 10e in the horizontal direction (for example, the X direction) of the electronic component 10. The terminal 13A and the terminal 13B are disposed to be arranged in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the X direction). An inner circumferential surface of the attachment hole 13h of electronic component 10 has a screw groove.

### (Attachment Portion)

The attachment portion 14 is a portion for fixing the electronic component 10. The attachment portion 14 has an attachment hole 14h to which a fastening member 112 (for example, a screw or a bolt; and see FIG. 11) that will be described later is attached. The attachment hole 14h is open in the Z direction. The attachment hole 14h is an insertion hole through which the fastening member 112 passes. A fixing destination of the attachment portion 14 will be described later.

### <3.1.2 Connection Component>

The connection component 20 is a component that electrically connects the electronic component 10 to the routing board 40. In the present embodiment, the connection component 20 electrically connects the electronic component 10 to the bus bar 42 (see FIG. 4) included in the routing board 40. The connection component 20 includes, for example, a first portion 21 and a second portion 22.

### (First Portion)

The first portion 21 of the connection component 20 is a portion connected to the terminal 13 of the electronic component 10. The first portion 21 is a plate-shaped or prismatic portion extending in the Z direction. The first portion 21 extends in the Z direction along the component end 10e (for example, a flat surface of the component end 10e in the X direction) which is one end portion of the electronic component 10. The first portion 21 is a standing portion that stands in the Z direction with respect to the routing board 40 (for example, with respect to a bus bar 42 that will be described later). The first portion 21 is adjacent to the electronic component 10 in the horizontal direction (for example, the X direction). For example, the first portion 21 is adjacent to the terminal 13 of the electronic component 10 in the horizontal direction (for example, the X direction), and is connected to the terminal 13 of the electronic component 10 from the horizontal direction (for example, the X direction).

The first portion 21 of the connection component 20 has a first attachment hole 21h through which the fastening member 71 (for example, a screw or a bolt) passes. The first attachment hole 21h is open in the horizontal direction (for example, the X direction). The fastening member 71 that has passed through the first attachment hole 21h is engaged with the attachment hole 13h of the terminal 13 of the electronic component 10, and thus the first portion 21 is physically and electrically connected to the terminal 13 of the electronic component 10. The fastening member 71 is an example of a first fastening portion.

### (Second Portion)

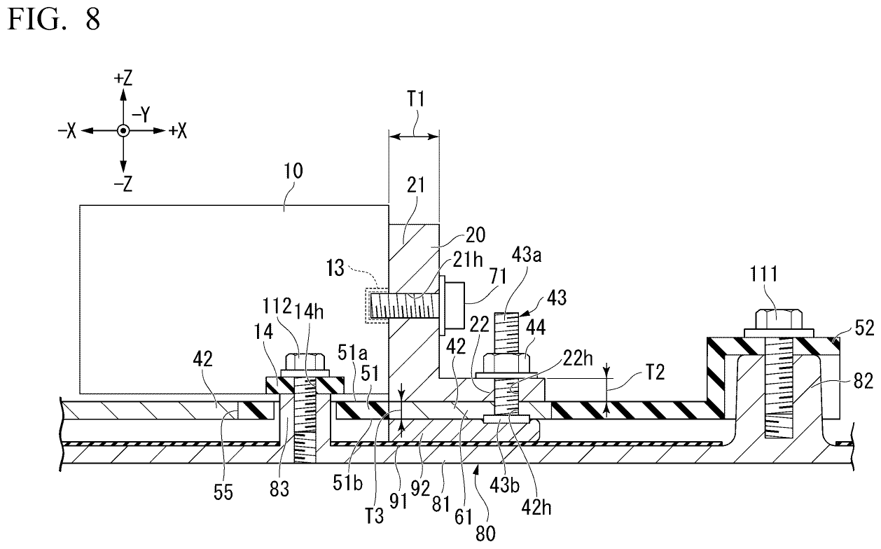

The second portion 22 of the connection component 20 is a portion connected to the bus bar 42 (see FIG. 8). The second portion 22 protrudes in the horizontal direction (for example, the X direction) from the end 10f of the first portion 21 on the −Z direction side. The second portion 22 is a plate portion provided in the horizontal direction and along the routing board 40. The second portion 22 is adjacent to the bus bar 42 in the Z direction, and is connected to the bus bar 42 from the +Z direction. The second portion 22 of the connection component 20 is physically and electrically connected to the bus bar 42 by being attached from the +Z direction to the fastening member 43 (for example, a screw or a bolt; and see FIG. 3) protruding from the bus bar 42 in the +Z direction. In the present embodiment, the second portion 22 of the connection component 20 has a second attachment hole 22h through which the fastening member 43 passes. The second attachment hole 22h is open in the Z direction. In the second portion 22, the fastening member 43 passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42. In the present embodiment, the first portion 21 and the second portion 22 form one piece of the connection component 20 having an L-shape in a side view viewed from the Y direction.

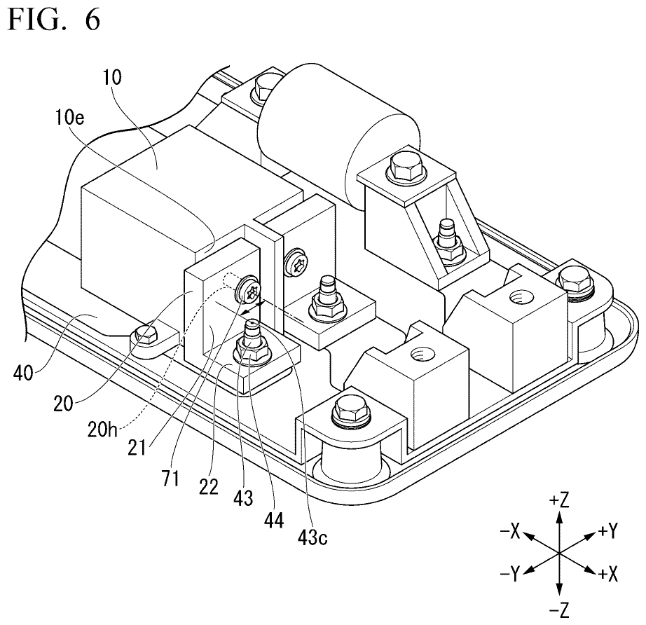

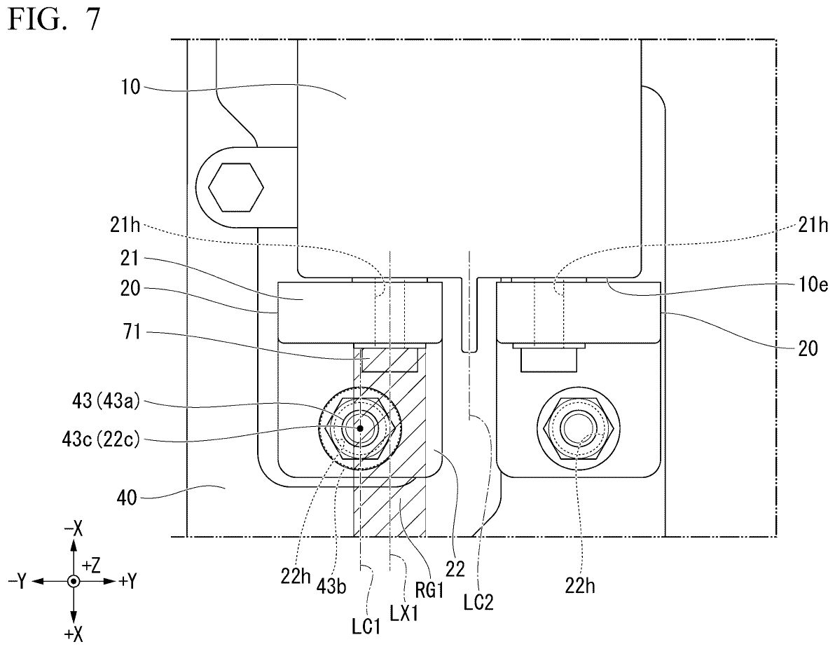

As illustrated in FIGS. 6 and 7, the position of the second attachment hole 22h is shifted to the −Y direction side with respect to the position of the first attachment hole 21h in the connection component 20. Specifically, as illustrated in FIG. 7, in a plan view viewed from the Z direction (first direction), the position of the second attachment hole 22h is shifted from the position aligned in the X direction (second direction) with respect to the position of the first attachment hole 21h. That is, in a plan view viewed from the Z direction, a hole center 22c of the second attachment hole 22h is shifted in the Y direction with respect to an extension line LX1 of the axis of the first attachment hole 21h. Such a positional relationship can also be said that the axis of the second attachment hole 22h is shifted in the Y direction with respect to the ZX plane including the axis of the first attachment hole 21h. For example, the position of the second attachment hole 22h may be shifted in the Y direction such that the hole center 22c of the second attachment hole 22h is located farther than the inner circumference of the first attachment hole 21h with respect to the extension line LX1 of the axis of the first attachment hole 21h in a plan view viewed from the Z direction. For example, the position of the second attachment hole 22h may be shifted in the Y direction such that the axis of the second attachment hole 22h is located outside the first attachment hole 21h in a side view viewed from the X direction.

As illustrated in FIG. 7, for example, in a plan view viewed from the Z direction, at least part of the fastening member 43 (including a head 43b and a shaft 43a that will be described later) may overlap an outer diameter region RG1 which is a region where a portion having the outermost diameter of the fastening member 71 extends in the X direction. Here, the “portion having the outermost diameter of the fastening member 71” may be the head of the fastening member 71. For example, in a plan view viewed from the Z direction, at least part of the shaft 43a of the fastening member 43 may overlap the outer diameter region RG1. For example, in a plan view as viewed from the Z direction, the shaft center 43c of the shaft 43a of the fastening member 43 may overlap the outer diameter region RG1.

For example, in a plan view viewed from the Z direction, the second attachment hole 22h may be located on a first center line LC1 which is a center line of the second portion 22 extending in the X direction. For example, in a plan view from the Z direction, the hole center 22c of the second attachment hole 22h may be located on the first center line LC1 of the second portion 22 extending in the X direction. Here, the first center line LC1 of the second portion 22 is a symmetry axis that divides the second portion 22 into line-symmetric portions in a plan view viewed from the Z direction.

For example, in a plan view viewed from the Z direction, the first attachment hole 21h may be closer to a second center line LC2 that is a center line of the component end 10e of the electronic component 10 extending in the X direction than the second attachment hole 22h. That is, in a plan view viewed from the Z direction, the first attachment hole 21h may be located at a position closer to the second center line LC2 of the component end 10e of the electronic component 10 extending in the X direction than the second attachment hole 22h. Here, the second center line LC2 of the component end 10e is a symmetry axis that divides the plane of the component end 10e in a side view viewed from the X direction into line-symmetric portions.

For example, in a case where the two connection components 20 are attached to the component end 10e of the electronic component 10 to be arranged in the Y direction, as illustrated in FIG. 7, for each connection component 20 in a plan view viewed from the Z direction, the first attachment hole 21h may be configured to be closer to the second center line LC2 of the component end 10e of the electronic component 10 extending in the X direction than the second attachment hole 22h. That is, the distance between the first attachment holes 21h of the two connection components 20 may be shorter than the distance between the second attachment holes 22h of the two connection components 20.

The connection component 20 is a heat storage member (heat absorbing member) that increases the heat capacity of the energization path of the electrical connection unit 1. The connection component 20 stores (absorbs) at least part of heat generated by the electronic component 10, for example. Alternatively/additionally, the connection component 20 may store (absorb) at least part of heat generated by the bus bar 42 due to energization. The connection component 20 may be referred to as a “heat storage component” or a “heat absorbing component”.

As illustrated in FIG. 8, the connection component 20 is disposed between the electronic component 10 and the bus bar 42. In the present disclosure, the phrase “the connection component is disposed between the electronic component and the bus bar” is not limited to a case where part of the connection component is located between the electronic component and the bus bar when viewed from the X direction or the Y direction. The phrase “the connection component is disposed between the electronic component and the bus bar” may correspond to a case where part of the connection component is located between the electronic component and the bus bar when viewed from a direction inclined with respect to the X direction or the Y direction. The connection component 20 electrically connects the terminal 13 of the electronic component 10 to the bus bar 42.

In the present embodiment, the thickness of at least part of the connection component 20 is larger than a plate thickness T3 of the bus bar 42. For example, a thickness T1 of at least part of the connection component 20 in the X direction is larger than the plate thickness T3 of the bus bar 42. In the present embodiment, the thickness T1 of the first portion 21 of the connection component 20 in the X direction is larger than the plate thickness T3 of the bus bar 42. In the present embodiment, the first portion 21 has a thickness T1 larger than the plate thickness T3 of the bus bar 42 as the thickness in the X direction over the entire length of the first portion 21 in the Z direction. From another point of view, a thickness T2 of the second portion 22 of the connection component 20 in the Z direction may be larger than the plate thickness T3 of the bus bar 42.

In the present embodiment, the thickness T1 of the first portion 21 of the connection component 20 in the X direction is larger than the thickness T2 of the second portion 22 of the connection component 20 in the Z direction. In the present embodiment, the first portion 21 has the thickness T1 larger than the thickness T2 of the second portion 22 over the entire length of the first portion 21 in the Z direction.

### <3.2 Routing Board>

Next, the routing board 40 will be described.

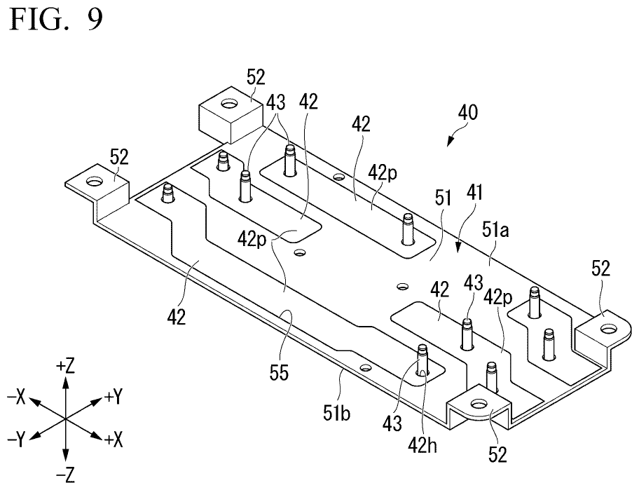

FIG. 9 is a perspective view illustrating the routing board 40. The routing board 40 is a member that forms at least part of an energization path between the plurality of electronic components 10 and/or at least part of an energization path between the electronic component 10 and an external device. In the present disclosure, the “routing board” indicates a board-type routing structure. The “board type” indicates a plate shape along one plane when viewed as a whole regardless of a fine shape. In the present disclosure, the “plate shape” is not limited to a completely flat shape, and may include a case where a fixing structure, a rib, or the like protruding in the Z direction is partially present. In the present embodiment, the routing board 40 has a plate shape formed in the X direction and the Y direction.

The routing board 40 includes, for example, a base plate 41, one or more (for example, a plurality of) bus bars 42, and a plurality of fastening members 43. In the present embodiment, the base plate 41 and the plurality of bus bars 42 are integrated through insert molding. For example, the routing board 40 is formed as a single member by insert-molding the bus bar 42 with the base plate 41 after the fastening member 43 is fixed to the bus bar 42. That is, the bus bar 42 is integrated with the base plate 41 without using a fastening member such as a screw or a bolt. Note that the routing board 40 may be formed by another structure instead of the insert molding.

### (Base Plate)

The base plate 41 is a holding member that integrally holds the plurality of bus bars 42 arranged in the horizontal direction at intervals. The base plate 41 is made of, for example, synthetic resin and has an insulating property. The base plate 41 electrically insulates the plurality of bus bars 42 from each other. The base plate 41 is an example of a “base member”. The base plate 41 may be referred to as an “insulating substrate”. The base plate 41 includes, for example, a flat surface portion 51 and a plurality of fixing portions 52.

The flat surface portion 51 is a portion formed in a plate shape in the base plate 41. The flat surface portion 51 has a plate shape formed in the horizontal direction. The flat surface portion 51 forms a main portion of the base plate 41. The flat surface portion 51 forms a base portion (insulating base portion) of the base plate 41. In the present embodiment, the flat surface portion 51 extends over the entire width in the X direction of the base plate 41 and over the entire width in the Y direction of the base plate 41 except for four corner portions of the base plate 41.

The flat surface portion 51 has a first surface 51a and a second surface 51b. The first surface 51a is a surface directed in the +Z direction. The first surface 51a is a flat surface provided in the horizontal direction. The first surface 51a faces the plurality of electronic components 10 and faces the insulating cover 93 (see FIG. 1) of the electrical connection unit 1. The second surface 51b is located on the side opposite to the first surface 51a. The second surface 51b is a surface directed in the −Z direction. The second surface 51b is a flat surface provided in the horizontal direction. The second surface 51b faces the metal plate 80 (see FIG. 1). A thickness direction (plate thickness direction) of the flat surface portion 51 is the Z direction.

### (Bus Bar)

The bus bar 42 is a routing member (electrical connection member) included in the routing board 40. The bus bar 42 is, for example, a routing member for electrically connecting the plurality of electronic components 10. Alternatively, the bus bar 42 may be a routing member for connecting the electronic component 10 to an external device. The bus bar 42 is made of a metal (for example, copper or a copper alloy) and has conductivity. In the present embodiment, in the routing board 40, the plurality of bus bars 42 include portions disposed on the same plane. Each bus bar 42 is held by the flat surface portion 51 of the base plate 41.

At least part of each bus bar 42 has a plate shape formed in the horizontal direction. At least part of each bus bar 42 is accommodated in the accommodation portion 55 and extends along the flat surface portion 51. That is, at least part of each bus bar 42 extends along the first surface 51a of the flat surface portion 51. At least part of each bus bar 42 extends in the horizontal direction in the accommodation portion 55. In the present embodiment, each bus bar 42 has a plate shape formed in the horizontal direction over the entire bus bar 42. Each of the bus bars 42 is accommodated in the accommodation portion 55 over the entire length of the bus bar 42 and extends along the flat surface portion 51. Hereinafter, a portion of each bus bar 42 that is accommodated in the accommodation portion 55 and extends along the flat surface portion 51 may be referred to as a “plate portion 42p”. The bus bar 42 is a member that forms a horizontal energization path. The bus bar 42 may be referred to as a “horizontal routing member”. Among the plurality of bus bars 42, some bus bars 42 may be, for example, bus bars included in a positive electrode line included in the electrical connection unit 1. Among the plurality of bus bars 42, some bus bars 42 other than the bus bars included in the positive electrode line may be, for example, bus bars included in the negative electrode line of the electrical connection unit 1.

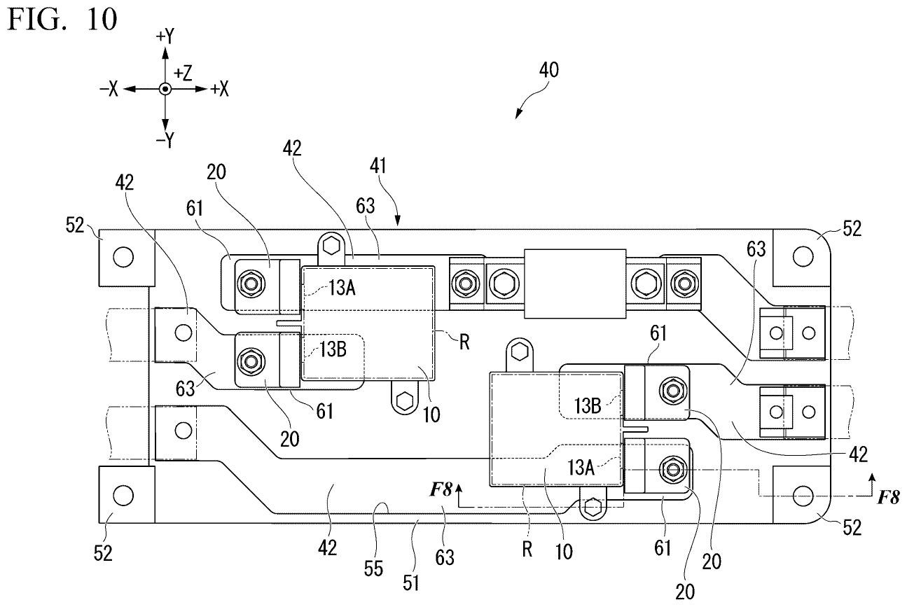

FIG. 10 is a plan view illustrating the routing board 40. The plate portion 42p of each bus bar 42 has, for example, a connection portion 61 and an extending portion 63.

The connection portion 61 is a portion in contact with one connection component 20. The connection component 20 is a connection component that connects one electronic component 10 to the bus bar 42. The connection portion 61 is a portion of the bus bar 42 overlapping the connection component 20 when viewed from the Z direction. The connection portion 61 is adjacent to the connection component 20 in the Z direction and is connected to the connection component 20 from the Z direction. For example, each connection portion 61 is located on the +X direction side or the −X direction side with respect to the electronic component 10 when viewed from the Z direction. Each connection portion 61 is electrically connected to the terminal 13A or the terminal 13B of the electronic component 10 via the connection component 20.

The extending portion 63 extends from the connection portion 61 in the X direction or the Y direction. The extending portion 63 is continuously connected to the connection portion 61.

In the present embodiment, the connection portion 61 and the extending portion 63 have a plate shape formed in the horizontal direction. In the present embodiment, each bus bar 42 is accommodated in the accommodation portion 55 at least over the connection portion 61 and the extending portion 63 and extends along the flat surface portion 51. For example, the connection portion 61 and the extending portion 63 are accommodated in the accommodation portion 55 and extend along the flat surface portion 51.

In the present embodiment, the extending portions 63 of some of the bus bars 42 are accommodated in the accommodation portion 55 to extend over both sides of a region R through the region R overlapping the electronic component 10 when viewed from the Z direction. For example, the extending portion 63 extends linearly in the X direction. The extending portion 63 extends over a region R overlapping the electronic component 10 when viewed from the Z direction, over the +X direction side and the −X direction side of the region R. That is, the bus bar 42 is accommodated in the accommodation portion 55 to be easily routed through a better path (for example, a path with a shorter distance) without being disturbed by the presence of the electronic component 10.

### (Fastening Member)

Referring to FIG. 8 again, the fastening member 43 is a component for fixing the bus bar 42 and the connection component 20. The fastening member 43 is, for example, a caulking bolt fixed to the bus bar 42. The fastening member 43 is an example of a “second fastening portion”.

In the present embodiment, the connection portion 61 of the bus bar 42 has a through-hole 42h. The through-hole 42h penetrates the bus bar 42 in the Z direction. The fastening member 43 is, for example, a bolt having a shaft 43a and a head 43b. A circumferential surface of the shaft 43a has a screw groove. The head 43b has a diameter larger than that of the shaft 43a. The head 43b of the fastening member 43 is caulked and fixed to the bus bar 42 in a state in which the shaft 43a passes through the through-hole 42h of the bus bar 42. With this fixation, the fastening member 43 is electrically and physically connected to the bus bar 42 in a state in which the shaft 43a protrudes in the +Z direction from the through-hole 42h of the bus bar 42. The fastening member 43 is not limited to caulking fixation, and may be fixed to the bus bar 42 through welding or other methods.

In the present embodiment, the connection component 20 is attached to the fastening member 43 from the Z direction in a state of being previously fixed to the electronic component 10 via the fastening member 71. For example, in the connection component 20, the shaft portion 43a of the fastening member 43 is inserted into the second attachment hole 22h of the second portion 22. The engagement member 44 (for example, a nut) is engaged with the shaft portion 43a of the fastening member 43 protruding from the second attachment hole 22h of the second portion 22 of the connection component 20. The engagement member 44 is attached to the shaft 43a in the Z direction, for example. This engagement fixes the second portion 22 of the connection component 20 to the fastening member 43.

### 4. Metal Plate, Insulating Sheet, Heat Transfer Member, and Insulating Cover

Next, the metal plate 80, the insulating sheet 91, the heat transfer member 92, and the insulating cover 93 will be described.

### <4.1 Metal Plate>

FIG. 11 is a partially exploded perspective view of the electrical connection unit 1. The metal plate 80 is a member for securing rigidity of the electrical connection unit 1 and enhancing a heat dissipation property of the electrical connection unit 1. The metal plate 80 is made of a metal (for example, aluminum or an aluminum alloy). The metal plate 80 may be referred to as a “rigid member”. In the present embodiment, each of the plurality of subunits SU (for example, the subunits SUX, SUY, and SUZ) is fixed to the metal plate 80. With this fixation, the plurality of subunits SU (for example, the subunits SUX, SUY, and SUZ) are held by one metal plate 80.

The metal plate 80 has a rectangular shape formed in the X direction when viewed from the Z direction. The metal plate 80 has a first end 80e1, a second end 80e2, a third end 80e3, and a fourth end 80e4. The first end 80e1 and the second end 80e2 are a pair of end portions of the metal plate 80 in the longitudinal direction, and are separated in the X direction. The third end 80e3 and the fourth end 80e4 are a pair of end portions of the metal plate 80 in the lateral direction, and are separated in the Y direction. The metal plate 80 includes, for example, a flat surface portion 81, a plurality of fixing portions 82, and a plurality of fixing portions 83.

The flat surface portion 81 is a portion formed in a plate shape in the metal plate 80. The flat surface portion 81 has a plate shape formed in the horizontal direction. The flat surface portion 81 forms a main portion of the metal plate 80. The flat surface portion 81 forms a base portion (metal base portion) of the metal plate 80. In the present embodiment, the flat surface portion 81 has a size that covers the three subunits SU from below. The flat surface portion 81 faces the routing boards 40 of the three subunits SU.

The fixing portion 82 is a fixing portion for fixing the base plate 41 of each subunit SU to the metal plate 80. The fixing portion 82 is provided at a position corresponding to the fixing portion 52 of the base plate 41 of each subunit SU when viewed from the Z direction. The fixing portion 82 is a cylindrical or prismatic boss protruding in the +Z direction from the flat surface portion 81 of the metal plate 80.

The fixing portion 83 is a fixing portion for directly fixing the electronic component 10 of each subunit SU to the metal plate 80 without interposing the base plate 41. The fixing portion 83 is provided at a position corresponding to the attachment portion 14 of the electronic component 10 of each subunit SU when viewed from the Z direction. The fixing portion 83 is a cylindrical or prismatic boss protruding in the +Z direction from the flat surface portion 81.

### <4.2 Insulating Sheet>

The insulating sheet 91 is an insulating member for electrically insulating the metal plate 80 and the bus bar 42 of each subunit SU. The insulating sheet 91 is made of, for example, a synthetic resin such as polyester or polyimide, and has an insulating property. The insulating sheet 91 has a rectangular shape when viewed from the Z direction. The insulating sheet 91 has a sheet shape formed in the horizontal direction. The insulating sheet 91 is disposed between the flat surface portion 81 of the metal plate 80 and the routing board 40 of each subunit SU. For example, the insulating sheet 91 is disposed between the flat surface portion 81 of the metal plate 80 and the plurality of heat transfer members 92.

In the present embodiment, the insulating sheet 91 is attached to the flat surface portion 81 of the metal plate 80. The insulating sheet 91 has a notch or an opening for avoiding the fixing portion 82 and the fixing portion 83 of the metal plate 80. Note that, instead of the above example, the insulating sheet 91 may be provided between the routing board 40 of each subunit SU and the plurality of heat transfer members 92.

### <4.3 Heat Transfer Member>

The heat transfer member 92 is a member for transferring heat generated by the electronic component 10 at the time of energization and/or heat generated by the bus bar 42 itself at the time of energization to the metal plate 80. The heat transfer member 92 is, for example, a heat transfer sheet (for example, a thermally conductive silicone sheet) having elasticity. However, the heat transfer member 92 is not limited to the above example, and may be a heat transfer member made of a thermally conductive gel or another material.

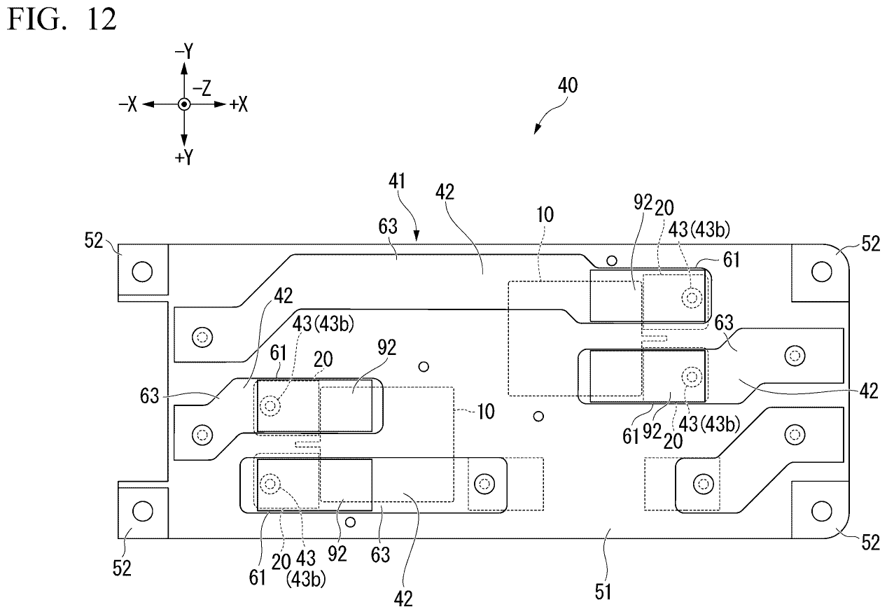

FIG. 12 is a bottom view illustrating the routing board 40. In the present embodiment, the plurality of heat transfer members 92 are partially provided in the routing board 40. For example, the plurality of heat transfer members 92 are disposed at positions overlapping part of the bus bar 42 when viewed from the Z direction. More specifically, the plurality of heat transfer members 92 are disposed at positions overlapping part of the bus bar 42 in the vicinity of the electronic component 10 when viewed from the Z direction. In the present embodiment, the plurality of heat transfer members 92 are disposed at positions overlapping the connection component 20 when viewed from the Z direction.

The heat transfer member 92 is disposed between the metal plate 80 and the bus bar 42. The heat transfer member 92 transfers heat transferred from the electronic component 10 to the bus bar 42 and/or heat generated by the bus bar 42 from the bus bar 42 to the metal plate 80.

In the present embodiment, part of the heat transfer member 92 is in contact with the bus bar 42 at a position overlapping the connection component 20 when viewed from the Z direction. In this case, the heat transfer member 92 easily transfers the heat transferred from the terminal 13 of the electronic component 10 to the connection component 20 from the connection component 20 to the metal plate 80 via the bus bar 42.

In the present embodiment, part of the heat transfer member 92 is disposed at a position overlapping the head 43b of the fastening member 43 when viewed from the Z direction, and is in contact with the head 43b of the fastening member 43. In this case, the heat transfer member 92 easily transfers the heat transferred from the terminal 13 of the electronic component 10 to the connection component 20 from the fastening member 43 to the metal plate 80.

In the present embodiment, part of the heat transfer member 92 is in contact with the bus bar 42 at a position overlapping the electronic component 10 when viewed from the Z direction. In this case, the heat transfer member 92 easily transfers the heat transferred from the electronic component 10 to the bus bar 42 from the bus bar 42 to the metal plate 80. In the example illustrated in FIG. 8, the upper surface of the bus bar 42 is in contact with the electronic component 10, and thus the bus bar 42 is thermally connected to the electronic component 10. Note that the extending portion 63 may be thermally connected to the electronic component 10 in the bus bar 42.

### <4.4 Insulating Cover>

Referring to FIG. 1 again, the insulating cover 93 will be described. The insulating cover 93 is a member for securing safety of the main body MU with respect to the energization path. The insulating cover 93 is made of, for example, a synthetic resin and has an insulating property. The insulating cover 93 has, for example, a box shape that is open on the −Z direction side. The insulating cover 93 has a plurality of vent holes 93h. The insulating cover 93 is attached to the metal plate 80 in the Z direction. Note that the insulating cover 93 is not limited to a box-shaped member, and may be a sheet-shaped member that covers the energization path of the main body MU.

### 5. Method of Manufacturing Electrical Connection Unit

Next, a method of manufacturing the electrical connection unit 1 will be described.

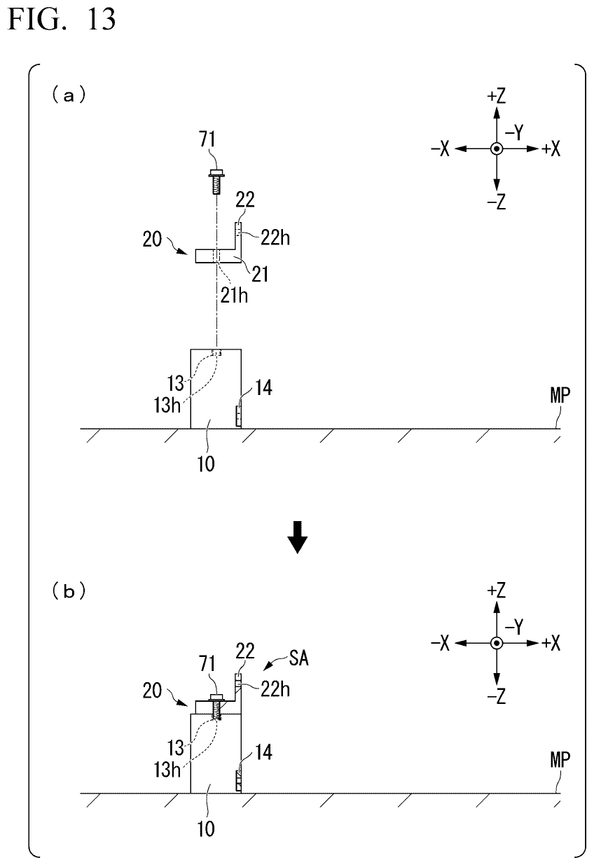

FIGS. 13 to 17 are cross-sectional views for describing the method of manufacturing the electrical connection unit 1. In the routing board 40 of each subunit SU, the base plate 41 and the plurality of bus bars 42 are integrated through insert molding or another method in a state in which the fastening member 43 is fixed to the bus bar 42. This integration allows the routing board 40 of each subunit SU to be prepared in advance.

### First Step

FIG. 13 illustrates a first step. In the first step, the connection component 20 is fixed to the terminal 13 of the electronic component 10 by using the fastening member 71. This fixation forms an assembly SA in which the electronic component 10 and the connection component 20 are integrated.

The first step is performed, for example, as follows. First, the electronic component 10 is placed on a placement table MP in a posture in which the attachment hole 13h of the terminal 13 of the electronic component 10 is directed in the vertical direction. Next, the connection component 20 is placed on the electronic component 10 in a posture in which the first attachment hole 21h of the connection component 20 is directed in the vertical direction. The first attachment hole 21h of the connection component 20 and the attachment hole 13h of the terminal 13 of the electronic component 10 are aligned. The first step is performed in a state in which the electronic component 10 and the connection component 20 are in a first posture. The first posture is a posture in which the attachment hole 13h and the first attachment hole 21h are directed in the vertical direction.

Next, the fastening member 71 is inserted into the first attachment hole 21h of the connection component 20 from the vertical direction. The fastening member 71 that has passed through the first attachment hole 21h of connection component 20 is engaged with the attachment hole 13h of the terminal 13 of the electronic component 10. This engagement forms an assembly SA in which the electronic component 10 and the connection component 20 are integrated. The vertical direction is an example of a “first attachment direction”.

### Second Step

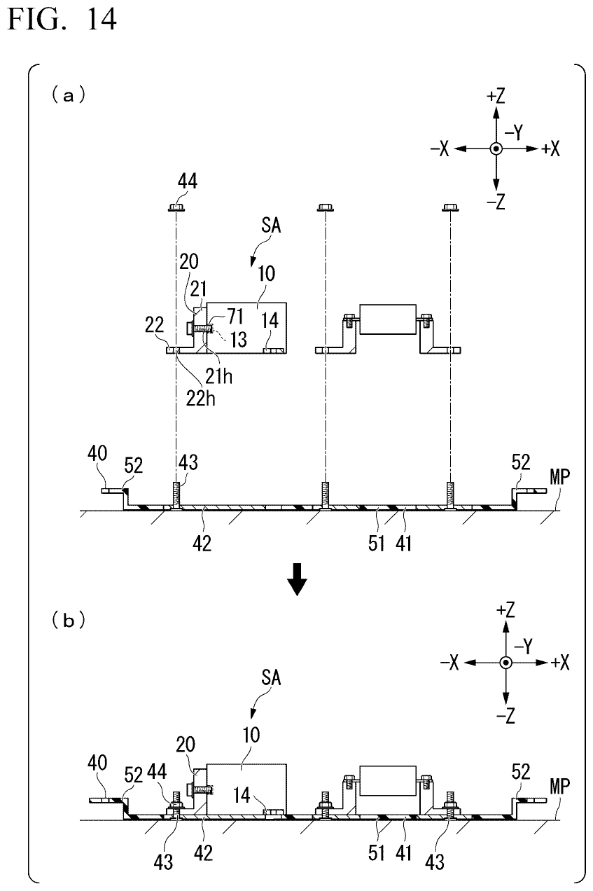

FIG. 14 illustrates a second step. In the second step, the assembly SA is fixed to the routing board 40 of each subunit SU. For example, the connection component 20 included in the assembly SA is fixed to the bus bar 42 included in the routing board 40. This fixation electrically connects electronic component 10 to bus bar 42.

The second step is performed, for example, as follows. As described above, in the routing board 40, the fastening member 43 is fixed to the bus bar 42. The fastening member 43 protrudes in the vertical direction from the bus bar 42. The assembly SA is placed on the routing board 40 such that the fastening member 43 is inserted into the second attachment hole 22h of the second portion 22 of the connection component 20 in the vertical direction. Next, the engagement member 44 (for example, a nut) is engaged with the upper end of the fastening member 43 from the vertical direction. This engagement fixes the second portion 22 of the connection component 20 included in the assembly SA to the bus bar 42. This fixation completes each subunit SU.

Here, the second step is performed as follows, for example. First, the posture of the assembly SA is rotated by 90 degrees from the first step. That is, the first posture (see FIG. 13) in which the attachment hole 13h and the first attachment hole 21h are directed in the vertical direction are changed to the second posture (see FIG. 14) in which the attachment hole 13h and the first attachment hole 21h are directed in the horizontal direction and the second attachment hole 22h of the connection component 20 are directed in the vertical direction.

In the second posture, the assembly SA is placed on the routing board 40 such that the fastening member 43 is inserted into the second attachment hole 22h of the second portion 22 of the connection component 20 in the vertical direction. Next, the engagement member 44 (for example, a nut) is engaged with the upper end of the fastening member 43 from the vertical direction. This engagement fixes the second portion 22 of the connection component 20 included in the assembly SA to the bus bar 42.

### Third Step

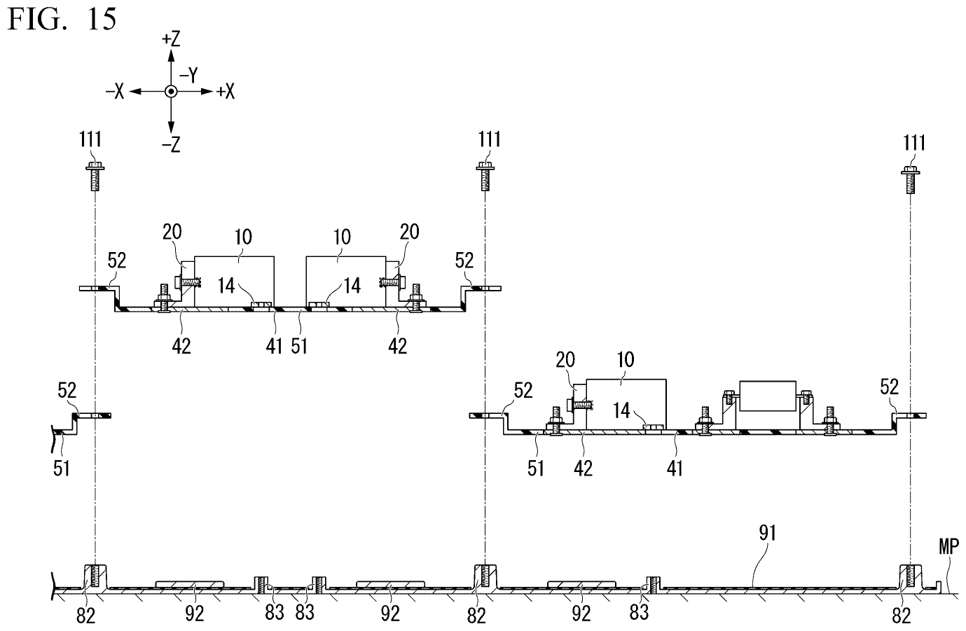

FIG. 15 illustrates a third step. In the third step, each subunit SU is attached to the metal plate 80. The third step is performed, for example, as follows. First, the insulating sheet 91 (see FIG. 11) is attached to the surface of the flat surface portion 81 of the metal plate 80. Next, the heat transfer member 92 is fixed to the lower surface of each subunit SU with an adhesive or the like. Next, each subunit SU is placed on the metal plate 80 with the insulating sheet 91 and the heat transfer member 92 interposed therebetween. The fixing portion 52 of each subunit SU is fixed to the fixing portion 82 of the metal plate 80 via the fastening member 111.

### Fourth Step

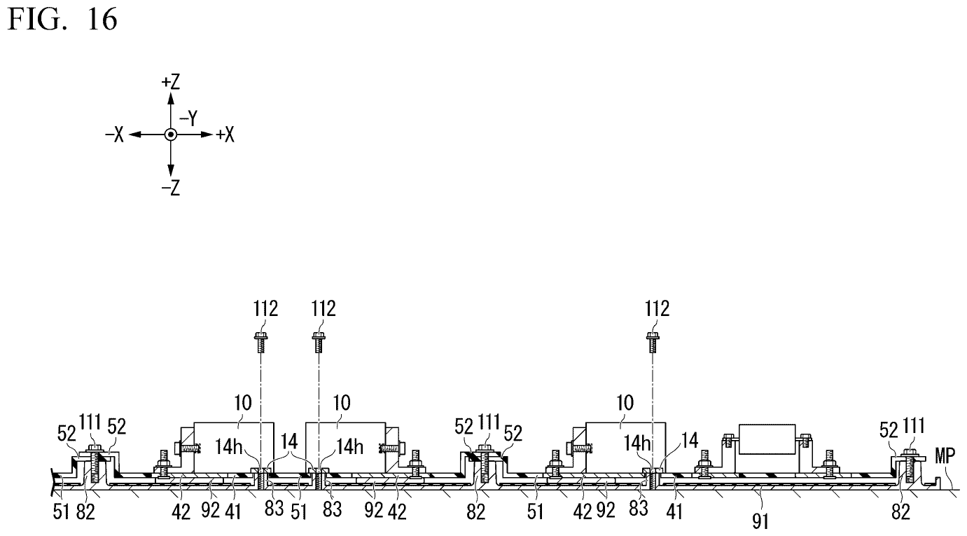

FIG. 16 illustrates a fourth step. In the fourth step, the attachment portion 14 of the electronic component 10 of each subunit SU is fixed to the fixing portion 83 of the metal plate 80 via the fastening member 112. The fourth step may be performed together with the third step.

### Fifth Step

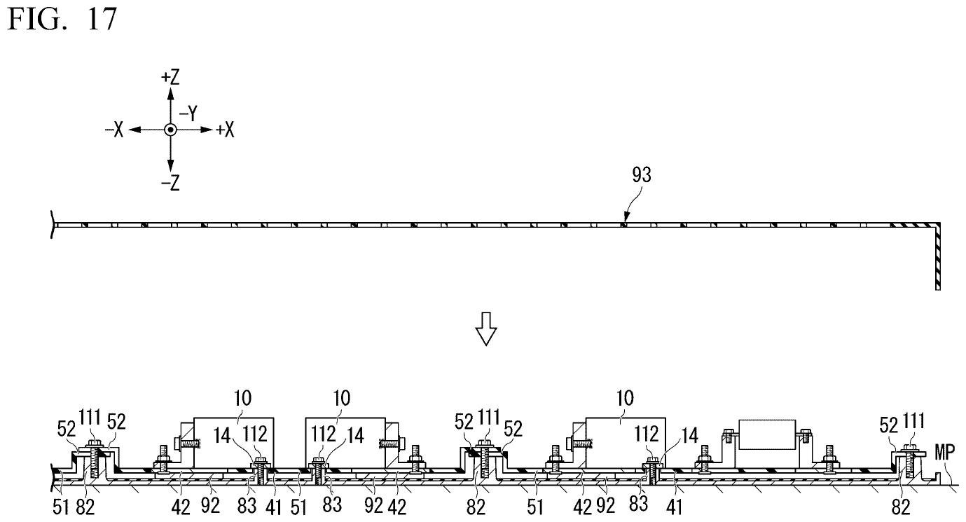

FIG. 17 illustrates a fifth step. In the fifth step, the insulating cover 93 is attached to the metal plate 80 in the vertical direction. This attachment completes the electrical connection unit 1.

### 6. Advantages

In the present embodiment, in a plan view viewed from the Z direction, the position of the second attachment hole 22h is shifted from the position aligned in the X direction with respect to the position of the first attachment hole 21h. With such a positional relationship, in the electrical connection unit 1, the position of the second attachment hole 22h can be brought close to the terminal 13. With such a close constitution, at least the dimension of the connection component 20 in the X direction is reduced. Therefore, it is possible to curb an increase in size of the electrical connection unit 1.

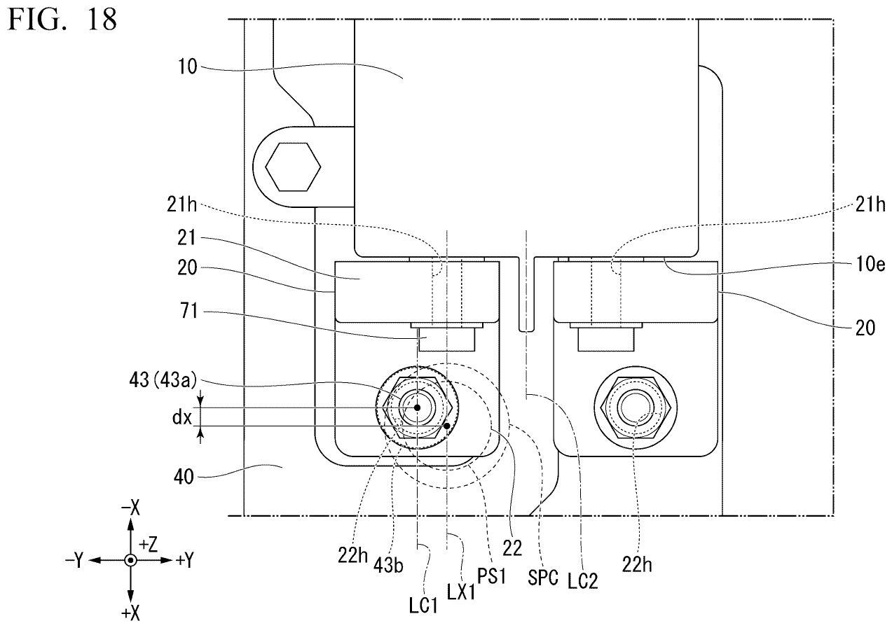

As a comparative example, it is assumed that the position of the second attachment hole of the second portion of the connection component is a position aligned in the X direction with respect to the position of the first attachment hole of the first portion of the connection component in a plan view viewed from the Z direction. In this positional relationship, in order to secure a fastening work space SPC using the fastening member of the second portion, the position where the fastening member of the second portion is provided is limited to a virtual position PS1 as illustrated in FIG. 18, which is a position sufficiently away from the fastening member of the first portion in the +X direction. Due to this limitation, in the comparative example, the dimension of the connection component in the X direction increases.

In contrast to this comparative example, according to the present embodiment, the fastening member 43 can be brought closer to the fastening member 71 by a distance corresponding to dX illustrated in FIG. 18 compared with the virtual position PS1. Therefore, as described above, the dimension of the connection component 20 in the X direction is reduced.

In each of the plurality of electronic components 10, in a case where the position of the second attachment hole 22h is brought close to the terminal 13 as described above, the following actions and effects can be expected. For example, when the above-described constitution is adopted between the plurality of electronic components 10 arranged adjacent to each other with the terminals 13 facing each other in one direction, the second attachment holes 22h can be separated from each other, and in the two adjacent electronic components 10, a distance between the second attachment holes 22h can be kept large. By maintaining such a distance, for example, an insulation distance between the fastening members 43 attached to the second attachment hole 22h can be secured, and the engagement members 44 engaged with the fastening members 43 can be separated. Therefore, insulation between the terminals of the two adjacent electronic components 10 can be secured.

Further, in the electronic component 10, in a case where the position of the second attachment hole 22h is brought close to the terminal 13 as described above, the following actions and effects can be expected. For example, in a case where there is another structure arranged facing the terminal 13 in one direction, when the above-described constitution is adopted, the other structure can be separated from the fastening member 43 and the engagement member 44 attached to the second attachment hole 22h. Therefore, an insulation distance between the terminal of the electronic component 10 and another structure can be secured.

In the present embodiment, a thickness of at least part of the connection component 20 is larger than the plate thickness T3 of the bus bar 42. According to such a constitution, the connection component 20 has a larger heat capacity per unit length than that of the bus bar 42. Due to this increase in heat capacity, even in a case where a short-term large current flows through the electronic component 10 and the electronic component 10 generates heat, part of the heat generated by the electronic component 10 is stored by the connection component 20. Such heat storage can curb a temperature change inside the electrical connection unit 1. Therefore, the thermal characteristics of the electrical connection unit 1 can be improved.

In the present embodiment, the fastening member 71 and the fastening member 43 are in a positional relationship in which at least part of the fastening member 43 overlaps the outer diameter region RG1 which is a region where a portion having the outermost diameter of the fastening member 71 extends in the X direction in a plan view viewed from the Z direction. According to such a positional relationship, the fastening member 43 can be brought close to the fastening member 71. Therefore, the dimension of the connection component 20 in the Y direction in a plan view is reduced.

In the present embodiment, in a plan view viewed from the Z direction, the second attachment hole 22h is located on the first center line LC1 of the second portion 22 extending in the X direction. In a case where the second attachment hole 22h is provided at such a position, the second portion 22 can be attached to the connection portion 61 on the center line of the second portion 22. Therefore, the connection component 20 can be stably attached to the bus bar 42.

In the present embodiment, in a plan view viewed from the Z direction, the first attachment hole 21h is located closer to the second center line LC2 extending in the Z direction of the component end 10e of the electronic component 10 than the second attachment hole 22h. According to such a positional relationship, the position of the first attachment hole 21h can be brought close to the center of the component end 10e of the electronic component 10. According to such a constitution, the dimension of the first portion 21 of the connection component 20 in the Y direction can be reduced. Therefore, it is possible to curb an increase in size of the connection component 20.

In the present embodiment, the thickness of the first portion 21 in the X direction is larger than a thickness of the second portion 22 in the X direction. According to such a constitution, a larger heat capacity can be secured by the first portion 21 of the connection component 20. Thus, the thermal characteristics of the electrical connection unit 1 can be further improved.

### 7. Modification Examples

Next, several modification examples will be described. Note that a constitution other than those described below in each modification example is the same as the constitution of the above-described embodiment.

In the above-described embodiment, in a plan view viewed from the Z direction, the position of the second attachment hole 22h is shifted from the position aligned in the X direction with respect to the position of the first attachment hole 21h, to the side of the component end 10e away from the second center line LC2 in the Y direction. However, when the dimension of the connection component 20 in the X direction is reduced, the position of the second attachment hole 22h may be shifted from the position of the first attachment hole 21h to any position. As a modification example, in a plan view viewed from the Z direction, the position of the second attachment hole 22h may be shifted from the position aligned in the X direction with respect to the position of the first attachment hole 21h, to the side closer to the second center line LC2 of the component end 10e in the Y direction.

The routing board 40 is not limited to a structure in which the base plate 41 and the bus bar 42 are integrated through insert molding. For example, the bus bar 42 may be disposed in the accommodation portion 55 after the base plate 41 provided with the accommodation portion 55 for accommodating the bus bar 42 is molded. In this case, the bus bar 42 may be fixed to the accommodation portion 55 through fitting, or may be fixed to the accommodation portion 55 via an adhesive or other fixing means. In these cases, potting may be performed to fill a gap between the bus bar 42 and the accommodation portion 55.

A base member of the routing board 40 is not limited to the base plate 41 having the plate-shaped flat surface portion 51. The routing board 40 may be a base member (for example, an insulating sheet) having a sheet-shaped flat surface portion 51. In this case, the accommodation portion 55 may be formed by part of the flat surface portion 51 following the outer shape of the bus bar 42.

Several embodiments and modification examples have been described above. However, the embodiment and the modification examples are not limited to the examples described above. For example, a plurality of embodiments may be implemented in combination with each other. The above-described embodiments can be implemented in various other forms, and various additions, omissions, substitutions, and changes can be made without departing from the concept of the present disclosure.

According to the present disclosure, it is possible to curb an increase in size of the electrical connection unit.

### REFERENCE SIGNS LIST

1 Electrical connection unit
10 Electronic component
10e Component end
10f End
10X Electronic component
10Y Electronic component
10Z Electronic component
11 Case
11a Insulating rib
12 Component body
13 Terminal
13A Terminal
13B Terminal
13h Attachment hole
14 Attachment portion
14h Attachment hole
20 Connection component
21 First portion
21h First attachment hole
22 Second portion
22c Hole center
22h Second attachment hole
40 Routing board
40M Routing board
40X Routing board
40Y Routing board
40Z Routing board
41 Base plate (base member)
42 Bus bar
42h Through-hole
42p Plate portion
43 Fastening member (second fastening portion)
43a Shaft
43b Head
43c Shaft center
44 Engagement member
51 Flat surface portion
51a First surface
51b Second surface
52 Fixing portion
55 Accommodation portion
61 Connection portion
63 Extending portion
71 Fastening member (first fastening portion)
80 Metal plate
80e1 First end
80e2 Second end
80e3 Third end
80e4 Fourth end
81 Flat surface portion
82 Fixing portion
83 Fixing portion
91 Insulating sheet
92 Heat transfer member
93 Insulating cover
93h Vent hole
111 Fastening member
112 Fastening member
LC1 First center line
LC2 Second center line
LX1 Extension line
MP Placement table
MU Main body
PS1 Virtual position
R Region
RG1 Outer diameter region
SA Assembly
SPC Fastening work space
SU Subunit
SUX Subunit
SUY Subunit
SUZ Subunit
10 T1 Thickness
T2 Thickness
T3 Plate thickness

What is claimed is:

1. An electrical connection unit comprising:
an electronic component including a terminal at a component end in a second direction;
a routing board including
a base member having a first surface facing the electronic component and including a plate-shaped or sheet-shaped flat surface portion having a thickness in a first direction, and
a bus bar held by the flat surface portion, extending along the flat surface portion, and including a connection portion; and
a connection component including
a first portion having a first attachment hole extending in the second direction and having a posture of standing in the first direction with respect to the first surface, and
a second portion having a second attachment hole extending in the first direction and protruding along the first surface from an end of the first portion on the first surface side,
the connection component being disposed between the electronic component and the bus bar and electrically connecting the terminal to the connection portion, wherein
in a plan view viewed from the first direction, a position of the second attachment hole is shifted from a position aligned in the second direction with respect to a position of the first attachment hole.

2. The electrical connection unit according to claim 1, wherein
a thickness of at least a part of the connection component is larger than a plate thickness of the bus bar.

3. The electrical connection unit according to claim 1, further comprising
a first fastening portion that passes through the first attachment hole and is attached to the terminal, wherein
the routing board further includes a second fastening portion that is fixed to the bus bar and passes through the second attachment hole, and
at least a part of the second fastening portion overlaps an outer diameter region that is a region where a portion having an outermost diameter of the first fastening portion extends in the second direction in the plan view viewed from the first direction.

4. The electrical connection unit according to claim 1, wherein
in the plan view, the second attachment hole is located on a first center line that is a center line of the second portion extending in the second direction.

5. The electrical connection unit according to claim 4, wherein
in the plan view, the first attachment hole is closer to a second center line that is a center line of the component end extending in the second direction than the second attachment hole.

6. The electrical connection unit according to claim 1, wherein
a thickness of the first portion in the second direction is larger than a thickness of the second portion in the first direction.
